(19) United States
(12) Patent Application Publication
(10) Pub. No.: US 2025/0270942 A1
(43) Pub. Date: Aug. 28, 2025

(54) SYSTEM AND METHOD FOR ASSEMBLING A FAN CASE OF A GAS TURBINE ENGINE

(71) Applicant: ROLLS-ROYCE plc, London (GB)

(72) Inventors: Marius MONORANU, Derby (GB); Charlie RICCARD, Bristol (GB)

(73) Assignee: ROLLS-ROYCE plc, London (GB)

(21) Appl. No.: 19/045,864

(22) Filed: Feb. 5, 2025

(30) Foreign Application Priority Data
Feb. 26, 2024 (GB) 2402652.8

(51) Int. Cl. F01D 25/24

(52) U.S. Cl. CPC F01D 25/24; F05D 2220/32; F05D 2230/23; F05D 2230/60; F05D 2240/14

(57) ABSTRACT

A system for assembling a fan case of a gas turbine engine includes at least one adhesive layer adapted to contact an inner surface of a fan case barrel of the fan case, an annular structure adapted to be disposed within the fan case barrel proximal to the inner surface of the fan case barrel, and at least one liner adapted to be removably coupled to the annular structure at a first annular surface of the annular structure. Based on a push force applied on the at least one liner, the at least one liner is adapted to detach from the annular structure and is pushed towards the inner surface of the fan case barrel to adhesively bond the at least one liner with the fan case barrel via the at least one adhesive layer.

### CROSS-REFERENCE TO RELATED APPLICATIONS

This specification is based upon and claims the benefit of priority from United Kingdom patent application number GB 2402652.8 filed on Feb. 26, 2024, the entire contents of which is incorporated herein by reference.

### BACKGROUND

### Technical Field

The present disclosure relates to a gas turbine engine, and in particular, to a system and a method for assembling a fan case of the gas turbine engine.

### Description of the Related Art

Generally, a gas turbine engine includes a fan assembly to push air through the gas turbine engine and provide thrust for an application, such as, an aircraft. The fan assembly typically includes a fan rotor, a plurality of fan blades coupled to the fan rotor, and a fan case that receives the fan rotor and the fan blades therein. In some examples, during a blade-off event, one or more fan blades may detach from the fan rotor while the gas turbine engine is operating. The detached fan blades may contact an inner surface of the fan case and may damage the fan case, which is not desirable. In other examples, foreign objects, e.g., ice or birds may be accidentally drawn into the gas turbine engine and may come in contact with the fan case, which may damage the fan case. Damage caused to the fan case by such impacts may decrease an operational efficiency of the gas turbine engine and, in some instances, may also cause safety issues, which is not desirable. Therefore, the fan assembly includes a number of impact liners that are coupled to the inner surface of the fan case to prevent damage to the fan case.

Conventionally, pre-manufactured impact liners are attached manually to the inner surface of the fan case one at a time using a corresponding film adhesive. Manual installation of the impact liners may involve a risk of damaging the impact liners prior to curing. Further, manual installation may cause misalignment of the impact liners relative to a desired configuration. For example, when the fan case is moved in/out of a measurement trolley prior to liner bonding, a roundness of the fan case can deviate from the desired configuration. This may lead to bonding of the impact liners to a non-circular/oval surface, thereby impacting a performance of the fan case. Overall, conventional techniques of liner installation may cause non-compliance with design requirements of the impact liner, which may negatively impact a quality and a durability of the impact liners.

Moreover, manual installation may lead to inconsistencies in positional and dimensional tolerances of the impact liners. In such cases, the impact liners may require additional manufacturing operations to meet the design requirements, which may increase manufacturing costs of the fan assembly. Further, conventional methods for installing the impact liners may be labour intensive and time consuming.

### SUMMARY

In a first aspect, there is provided a system for assembling a fan case of a gas turbine engine. The system includes at least one adhesive layer adapted to contact an inner surface of a fan case barrel of the fan case. The system further includes an annular structure adapted to be disposed within the fan case barrel proximal to the inner surface of the fan case barrel. The annular structure defines a first annular surface adapted to face the inner surface of the fan case barrel and a second annular surface radially opposite to the first annular surface. The system further includes at least one liner adapted to be removably coupled to the annular structure at the first annular surface of the annular structure. Based on a push force applied on the at least one liner, the at least one liner is adapted to detach from the annular structure and is pushed towards the inner surface of the fan case barrel to adhesively bond the at least one liner with the fan case barrel via the at least one adhesive layer.

The annular structure of the system is used to couple the liner to the inner surface of the fan case barrel of the fan case. The push force applied on the liner detaches the liner from the annular structure, so that the liner may adhesively bond with the fan case barrel via the adhesive layer.

The system of the present disclosure may ensure that the liners coupled to the fan case barrel meet the desired design requirement. Moreover, the system may minimise a risk of damaging the liners during installation of the liners, as compared to liners that are installed using conventional techniques. The installation of the liners using the system described herein may improve a quality and a durability of the liners. Further, the system ensures that a roundness requirement of the fan case barrel is achieved while the liners are being installed and also during the curing of the adhesive layer. Specifically, as the liners are installed when the fan case barrel is fully circular, a stiffness of the fan case barrel may increase and a required round shape of the fan case barrel may be achieved. Moreover, the system may be usable during first assembly or replacement of various types of liners, such as, impact liners and acoustic liners, without compromising an existing design of the liners.

The system of the present disclosure may eliminate any additional steps of machining that are inherent in liners that are installed using conventional techniques, thereby reducing manufacturing costs associated with the fan case. Furthermore, the liners installed using the system may be compliant to design requirements including profile tolerances, surface tolerances, positional tolerances, and dimensional tolerances. The system of the present disclosure may optimise installation safety, quality, and efficiency with which the liners are coupled to the fan case barrel.

The liners disposed on the fan case barrel may prevent damage to the fan case and the gas turbine engine by absorbing an energy of impact in an event of detachment of fan blade(s) or due to impact with foreign objects, e.g., ice or birds, which may be accidentally drawn into the gas turbine engine. Thus, the liners installed using the proposed system may improve a safety of the gas turbine engine and may maintain an operational efficiency of the gas turbine engine.

Further, the system described herein may be used as an on-site as well an off-site repair solution during servicing of the fan case. Furthermore, the system may be portable and easy to use.

In some embodiments, the system further includes a pressure strip removably coupled to the at least one liner, the at least one adhesive layer, and the fan case barrel. The pressure strip is adapted to fully enclose the adhesive layer. As the pressure strip fully encloses the at least one adhesive layer, the pressure strip may allow uniform distribution of pressure along a length of the adhesive layer. The pressure strip may provide spew control. In other words, the pressure strip may prevent a flow-out of the adhesive layer. The pressure strip may provide a uniform bond thickness of the adhesive layer with minimal to no voids in the adhesive layer. Moreover, as the voids are minimal, an adhesion between the liner and the fan case barrel may be improved, while also improving an in-service life and a functionality of the liner.

In some embodiments, the pressure strip includes at least one of a butyl rubber, a platinum cured rubber, a silicone based rubber, and a peroxide cured rubber. The pressure strip made of one of the above listed rubbers may fully enclose the adhesive layer so as to prevent the flow-out of the adhesive layer. This may result in the uniform bond thickness of the adhesive layer and minimal to no voids in the adhesive layer, thereby improving adhesion between the liner and the fan case barrel.

In some embodiments, the system further includes a pressure applicator adapted to apply a uniform pressure on the second annular surface of the annular structure to adhesively bond the at least one liner with the fan case barrel via the at least one adhesive layer.

The application of the uniform pressure on the annular structure may be in turn applied on the liner which may cause the liner to be pushed towards the fan case barrel for bonding, while maintaining the uniform bond thickness of the adhesive layer and minimal to no voids in the adhesive layer. Further, the pressure applicator may continue to apply the unform pressure during the curing of the adhesive layer. The uniform pressure applied by the pressure applicator may replicate pressures that are applied during a conventional vacuum bag process. Further, application of the uniform pressure on the liner may ensure that the fan case barrel is in a round state, thereby meeting the roundness requirement of the fan case barrel which may improve a quality of the fan case barrel.

In some embodiments, the pressure applicator includes one or more clamps, one or more actuators, or an inflatable ring. The one or more clamps, the one or more actuators, or the inflatable ring may ensure that the uniform pressure is being applied on the second annular surface of the annular structure so that the liner may adhere with the fan case barrel in a desired manner, while maintaining the uniform bond thickness of the adhesive layer and minimal to no voids in the adhesive layer.

In some embodiments, the system further includes one or more first coupling elements adapted to removably couple the at least one liner to the annular structure. The one or more first coupling elements may allow easy coupling of the liner to the annular structure and may be easy to remove when the liner is to be detached from the annular structure.

In some embodiments, each of the one or more first coupling elements includes a mechanical fastener or a coupling feature extending from the first annular surface of the annular structure. The mechanical fastener or the coupling feature may provide benefits in terms of easy coupling of the liner to the annular structure and easy removal when the liner is to be detached from the annular structure.

In some embodiments, the system further includes a detachment device adapted to apply the push force to detach the at least one liner from the annular structure. The push force may be applied by the detachment device to detach the liners from the annular structure and dispose the liners in a bonding position.

In some embodiments, the detachment device includes one or more clamps, one or more actuators, or an inflatable ring. The one or more clamps, the one or more actuators, or the inflatable ring may ensure easy detachment of the liners from the annular structure to dispose the liners in the bonding position.

In some embodiments, the system further includes one or more second coupling elements adapted to removably couple the annular structure to the fan case barrel. The one or more second coupling elements may allow easy coupling of the annular structure with the fan case barrel and may be easy to remove from the annular structure after curing of the adhesive layer. Each of the one or more second coupling elements may also maintain the position of the liners relative to the fan case barrel while the adhesive layers are being cured. Specifically, each of the one or more second coupling elements may be used to control positional tolerances of the liners while the adhesive layers are being cured.

In some embodiments, each of the one or more second coupling elements includes a mechanical fastener. The mechanical fastener may provide benefits in terms of easy coupling of the annular structure with the fan case barrel and easy removal of the annular structure after curing of the adhesive layer. The mechanical fasteners may also maintain the position of the liners relative to the annular structure while the adhesive layers are being cured.

In some embodiments, the at least one adhesive layer includes a plurality of adhesive layers that are circumferentially spaced apart from each other. The at least one liner includes a plurality of liners corresponding to the plurality of adhesive layers. The plurality of liners are adapted to be removably coupled to the annular structure and are circumferentially spaced apart from each other. Upon application of the push force on each of the plurality of liners, each of the plurality of liners detaches from the annular structure and is pushed towards the inner surface of the fan case barrel to adhesively bond each of the plurality of 25 liners with the fan case barrel via a corresponding adhesive layer from the plurality of adhesive layers.

The plurality of adhesive layers may be circumferentially spaced apart from each other. Each of the plurality of adhesive layers may be disposed between a corresponding liner and the fan case barrel. Due to the push force on each of the plurality of liners, each of the plurality of liners detaches from the annular structure and is adhesively bonded to the inner surface of the fan case barrel via the corresponding adhesive layer. The plurality of liners adhesively bonded at the inner surface of the fan case barrel may prevent damage to the fan case barrel by absorbing the energy of impact in examples wherein one or more fan blades of the gas turbine engine detaches from a fan rotor in case of a blade-off event or during impact of the fan case barrel with foreign objects that may be accidentally drawn into the gas turbine engine.

In some embodiments, when each of the plurality of liners is removably coupled to the annular structure, each of the plurality of liners is disposed in a first position. In the first position, each liner from the plurality of liners is circumferentially spaced apart from an adjacent liner from the plurality of liners by a first gap. In the first position, each of the plurality of liners may be removably coupled to the annular structure in a retracted position by using the one or more first coupling elements.

In some embodiments, upon detachment of each of the plurality of liners from the annular structure, each of the plurality of liners is disposed in a second position. In the second position, each liner from the plurality of liners is circumferentially spaced apart from the adjacent liner from the plurality of liners by a second gap. The second gap is greater than the first gap. The second gap may be observed between the adjacent liners after applying the push force to detach the liners from the annular structure. The second gap may be governed as per design requirements.

In a second aspect, there is provided a method for assembling a fan case of a gas turbine engine. The method includes providing an annular structure. The annular structure defines a first annular surface and a second annular surface radially opposite to the first annular surface. The method further includes removably coupling at least one liner to the annular structure at the first annular surface of the annular structure. The method further includes disposing the annular structure within a fan case barrel of the fan case. The annular structure is disposed proximal to an inner surface of the fan case barrel, such that the first annular surface of the annular structure faces the inner surface of the fan case barrel. The method further includes disposing at least one adhesive layer between the at least one liner and the inner surface of the fan case barrel. The at least one adhesive layer is adapted to adhesively bond the at least one liner with the fan case barrel. The method further includes applying a push force on the at least one liner to detach the at least one liner from the annular structure. The method further includes pressing the at least one liner towards the inner surface of the fan case barrel to adhesively bond the at least one liner with the fan case barrel, upon application of the push force on the at least one liner.

The liners coupled to the fan case barrel using the proposed method may meet the desired design requirement. Moreover, the method may minimise a risk of damaging the liners during coupling of the liners, as compared to liners that are coupled using conventional techniques. The liners coupled using the method described herein may improve a quality and a durability of the liners. Further, the method ensures that a roundness requirement of the fan case barrel is achieved while the liners are being installed and also during the curing of the adhesive layer. Specifically, as the liners are installed when the fan case barrel is fully circular, a stiffness of the fan case barrel may increase, and a required round shape of the fan case barrel may be achieved. Moreover, the method may be usable during first assembly or replacement of various types of liners, such as, impact liners and acoustic liners, without compromising an existing design of the liners.

The method of the present disclosure may eliminate any additional steps of machining that are inherent in liners that are installed using conventional techniques, thereby reducing manufacturing costs associated with the fan case. Furthermore, the liners installed using the method may be compliant to design requirements including profile tolerances, surface tolerances, positional tolerances, and dimensional tolerances. The method of the present disclosure may optimise installation safety, quality, and efficiency with which the liners are coupled to the fan case barrel.

The liners disposed on the fan case barrel may prevent damage to the fan case and the gas turbine engine by absorbing an energy of impact in an event of detachment of fan blade(s) or due to impact with foreign objects, e.g., ice or birds, which may be accidentally drawn into the gas turbine engine. Thus, the liners installed using the proposed method may improve a safety of the gas turbine engine and may maintain an operational efficiency of the gas turbine engine.

Further, the method described herein may be used as an on-site as well an off-site repairing of the fan case.

In some embodiments, the method further includes removably coupling a pressure strip to the at least one liner, the at least one adhesive layer, and the fan case barrel. The pressure strip is adapted to fully enclose the at least one adhesive layer. As the pressure strip fully encloses the adhesive layer, the pressure strip may allow uniform distribution of pressure along a length of the adhesive layer. The pressure strip may provide spew control. In other words, the pressure strip may prevent a flow-out of the adhesive layer. The pressure strip may provide a uniform bond thickness of the adhesive layer with minimal to no voids in the adhesive layer. As the voids are minimal, the adhesion between the liner and the fan case barrel may be improved, while also improving an in-service life and a functionality of the liner.

In some embodiments, the method further includes applying, via a pressure applicator, a uniform pressure on the second annular surface of the annular structure to adhesively bond the at least one liner with the fan case barrel via the at least one adhesive layer.

The application of the uniform pressure on the annular structure may be in turn applied on the liner which may cause the liner to adhesively bond with the fan case barrel in a desired manner, while maintaining the uniform bond thickness of the adhesive layer and minimal to no voids in the adhesive layer. Further, the pressure applicator may continue to apply the unform pressure during the curing of the adhesive layer. The uniform pressure applied by the pressure applicator may replicate pressures that are applied during a conventional vacuum bag process. Further, application of the uniform pressure on the liner may ensure that the fan case barrel is in a round state, thereby meeting the roundness requirement of the fan case barrel which may improve a quality of the fan case barrel.

In some embodiments, the step of removably coupling the at least one liner to the annular structure at the first annular surface of the annular structure further includes removably coupling, via one or more first coupling elements, the at least one liner to the annular structure. The one or more first coupling elements may allow easy coupling of the liner to the annular structure and may be easy to remove when the liner is to be detached from the annular structure.

In some embodiments, the step of applying the push force further includes applying, via a detachment device, the push force to detach the at least one liner from the annular structure. The push force may be applied by the detachment device to detach the liners from the annular structure and dispose the liners in a bonding position.

In some embodiments, the method further includes removably coupling, via one or more second coupling elements, the annular structure to the fan case barrel. The one or more second coupling elements may allow easy coupling of the annular structure with the fan case barrel and may be easy to remove from the annular structure after curing of the adhesive layer. Each of the one or more second coupling elements may also maintain the position of the liners relative to the fan case barrel while the adhesive layers are being cured. Specifically, each of the one or more second coupling elements may be used to control positional tolerances of the liners while the adhesive layers are being cured.

In some embodiments, the at least one adhesive layer includes a plurality of adhesive layers that are circumferentially spaced apart from each other. The at least one liner includes a plurality of liners corresponding to the plurality of adhesive layers. The plurality of liners are adapted to be removably coupled to the annular structure and are circumferentially spaced apart from each other. Each of the plurality of liners is adapted to be adhesively bonded to the inner surface of the fan case barrel by a corresponding adhesive layer from the plurality of adhesive layers. The step of applying the push force on the at least one liner further includes applying the push force on each of the plurality of liners to detach each of the plurality of liners from the annular structure.

The plurality of adhesive layers may be circumferentially spaced apart from each other. Each of the plurality of adhesive layers may be disposed between a corresponding liner and the fan case barrel. Due to the push force on each of the plurality of liners, each of the plurality of liners detaches from the annular structure and is adhesively bonded to the inner surface of the fan case barrel via the corresponding adhesive layer. The plurality of liners adhesively bonded at the inner surface of the fan case barrel may prevent damage to the fan case barrel by absorbing the energy of impact in examples wherein one or more fan blades of the gas turbine engine detaches from a fan rotor in case of a blade-off event or during impact of the fan case barrel with foreign objects that may be accidentally drawn into the gas turbine engine.

In some embodiments, the step of removably coupling the at least one liner to the annular structure at the first annular surface of the annular structure further includes removably coupling each of the plurality of liners to the first annular surface in a first position. In the first position, each liner from the plurality of liners is circumferentially spaced apart from an adjacent liner from the plurality of liners by a first gap. In the first position, each of the plurality of liners may be removably coupled to the annular structure in a retracted position by using the one or more first coupling elements.

In some embodiments, the method further includes disposing, upon detachment of each of the plurality of liners from the annular structure, each of the plurality of liners in a second position. In the second position, each liner from the plurality of liners is circumferentially spaced apart from the adjacent liner from the plurality of liners by a second gap. The second gap is greater than the first gap. The second gap may be observed between the adjacent liners after applying the push force to detach the liners from the annular structure. The second gap may be governed as per design requirements.

In a third aspect, there is provided a gas turbine engine. The gas turbine engine includes the fan case assembled by the method of the second aspect. The fan case may be assembled in a cost-effective manner and may have a longer service life due to the liners bonded at the inner surface of the fan case barrel.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed). The gearbox may be a reduction gearbox (in that the output to the fan is a lower rotational rate than the input from the core shaft). Any type of gearbox may be used.

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. The bypass duct may be substantially annular. The bypass duct may be radially outside the engine core. The radially outer surface of the bypass duct may be defined by a nacelle and/or the fan case. A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fibre. The fan of a gas turbine as described and/or claimed herein may have any desired number of fan blades, for example 14, 16, 18, 20, 22, 24 or 26 fan blades.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic side view of a gas turbine engine;

FIG. 2 is a schematic perspective view of a fan case of the gas turbine engine of FIG. 1;

FIG. 3 is a schematic perspective view of a liner associated with the fan case of FIG. 2;

FIG. 4 is a schematic perspective view of a system for assembling the fan case of FIG. 2, according to an embodiment of the present disclosure;

FIG. 5 is a schematic cross-sectional view of a portion of the system of FIG. 4;

FIG. 6 is a schematic cross-sectional view of a portion of the system of FIG. 4;

FIG. 7 is a schematic cross-sectional side view illustrating a detachment device of the system of FIG. 4 for detaching a liner of the system from an annular structure of the system;

FIG. 8 is a schematic cross-sectional side view illustrating the liner of FIG. 7 detached from the annular structure of FIG. 7;

FIG. 9A is a schematic cross-sectional top view illustrating a position of two adjacent liners of the system of FIG. 4 before applying a push force on the liners;

FIG. 9B is a schematic cross-sectional top view illustrating a position of the two adjacent liners of FIG. 4 after applying the push force;

FIG. 10 is a schematic top view illustrating a pressure applicator of the system of FIG. 4; and

FIG. 11 is a flowchart for a method for assembling the fan case of FIG. 2.

### DETAILED DESCRIPTION

Aspects and embodiments of the present disclosure will now be discussed with reference to the accompanying figures. Further aspects and embodiments will be apparent to those skilled in the art.

As used herein, the term “configured to” and like is at least as restrictive as the term “adapted to” and requires actual design intention to perform the specified function rather than mere physical capability of performing such a function.

As used herein, the terms “first”, “second”, and “third” are used as identifiers. Therefore, such terms should not be construed as limiting of this disclosure. The terms “first”, “second”, and “third”, when used in conjunction with a feature or an element can be interchanged throughout the embodiments of this disclosure.

As used herein, “at least one of A and B” should be understood to mean “only A, only B, or both A and B”.

As used herein, the term “partially” refers to any percentage greater than 1%. In other words, the term “partially” refers to any amount of a whole. For example, “partially” may refer to a small portion, half, or a selected portion of a whole. In some cases, “partially” may refer to a whole amount. The term “partially” refers to any percentage less than 100%.

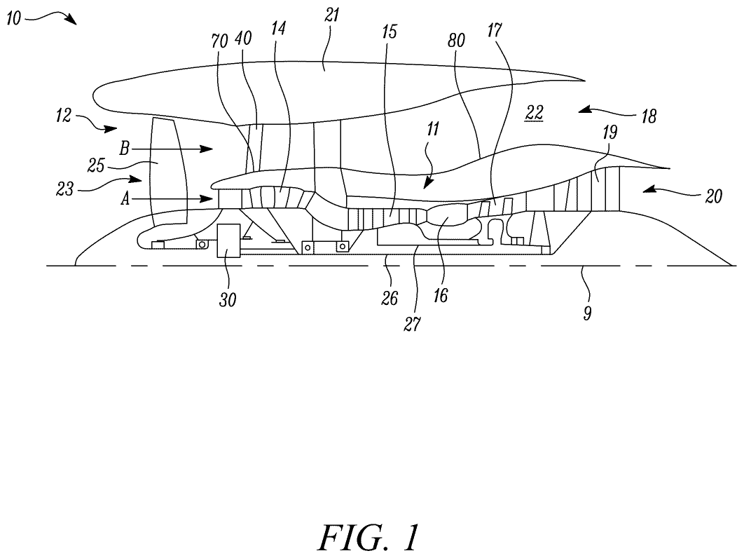

FIG. 1 illustrates a schematic side view of a gas turbine engine 10 having a principal rotational axis 9. The gas turbine engine 10 comprises an air intake 12 and a fan 23 that generates two airflows: a core airflow A and a bypass airflow B. The gas turbine engine 10 comprises an engine core 11 that receives the core airflow A. In other words, the core airflow A enters the engine core 11. The fan 23 is located upstream of the engine core 11. The fan 23 includes a plurality of fan blades 25 (only one is shown herein for illustrative purposes) that upon rotating, generates the core airflow A and the bypass airflow B.

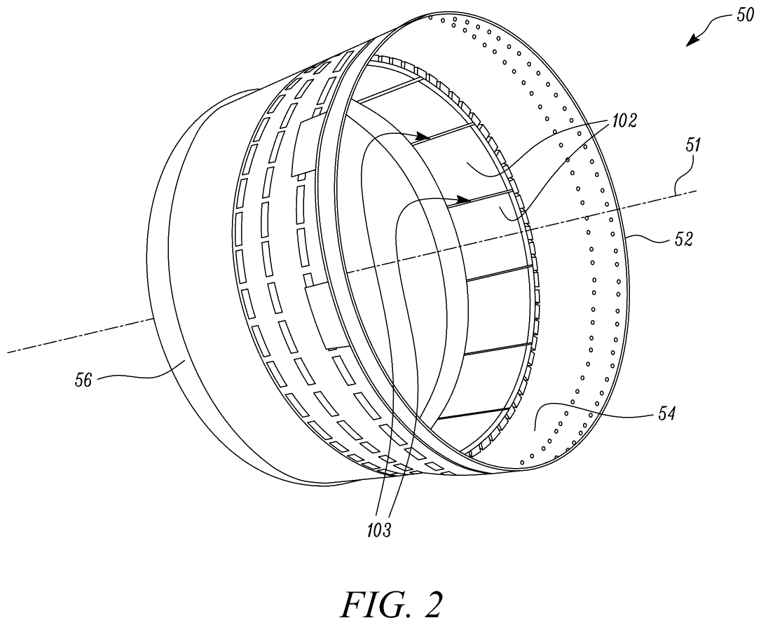

The engine core 11 comprises, in axial flow series, a compressor, a combustor, and a turbine. Specifically, the engine core 11 comprises, in axial flow series, a low pressure compressor 14, a high pressure compressor 15, a combustor 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22 surrounding the engine core 11. The bypass airflow B flows through the bypass duct 22 to provide propulsive thrust, where it is straightened by a row of outlet guide vanes 40 before exiting the bypass exhaust nozzle 18. The outlet guide vanes 40 extend radially outwardly from an inner ring 70 which defines a radially inner surface of the bypass duct 22. Rearward of the outlet guide vanes 40, the engine core 11 is surrounded by an inner cowl 80 which provides an aerodynamic fairing defining the inner surface of the bypass duct 22. The inner cowl 80 is rearwards of and axially spaced from the inner ring 70. A fan case 50 (shown in FIG. 2) defines an outer surface of the bypass duct 22. The inner ring 70 defines the inner surface of the bypass duct 22 towards the rear of the fan case 50. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustor 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. A core shaft 27 connects the turbine 17, 19 to the compressor 14, 15. Specifically, the high pressure turbine 17 drives the high pressure compressor 15 by the suitable core shaft 27 or an interconnecting shaft. The fan 23 generally provides the majority of the propulsive thrust. The epicyclic gearbox 30 is a reduction gearbox.

FIG. 2 illustrates a schematic perspective view of the fan case 50 of the gas turbine engine 10 (see FIG. 1), according to an embodiment of the present disclosure. As shown in FIG. 2, the fan case 50 includes a central axis 51. The fan case 50 includes a fan case barrel 52 that extends axially and circumferentially along the central axis 51. The central axis 51 may be aligned with the principal rotational axis 9 (see FIG. 1). The fan case barrel 52 may be made of a carbon fiber composite, for example. The fan case barrel 52 includes an inner surface 54 and an outer surface 56 radially opposite to the inner surface 54. The inner surface 54 of the fan case barrel faces the fan blades 25 (see FIG. 1).

The inner surface 54 of the fan case barrel 52 is coupled with a plurality of liners 102. Moreover, a gap 103 is present between each liner 102 and an adjacent liner 102 of the plurality of liners 102. During a blade-off event, a portion of one or more fan blades 25 or one or more complete fan blades 25 may detach from the fan 23 (see FIG. 1). In other examples, foreign objects, e.g., ice or birds may be accidentally drawn into the gas turbine engine 10 and may come in contact with the fan case barrel 52. In such events, the liners 102 may absorb and energy of impact to prevent damage to the fan case barrel 52. Further, the liner 102 may also improve a safety of the gas turbine engine 10 and may maintain an operational efficiency of the gas turbine engine 10.

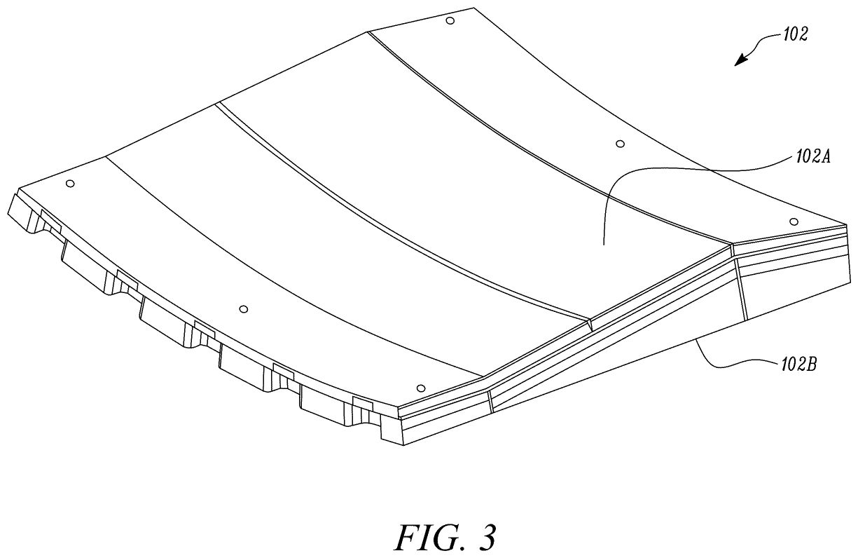

FIG. 3 illustrates a schematic perspective view of the single liner 102 associated with the fan case 50 (see FIG. 2), according to an embodiment of the present disclosure. As shown in FIG. 3, the liner 102 includes a first major surface 102A and a second major surface 102B. It should be noted that the liner 102 may include a plurality of layers (not numbered herein) between the first major surface 102A and the second major surface 102B that together define the liner 102. For example, the liner 102 may include an abradable layer, an adhesive layer, an insulation layer, and/or a base layer, without any limitations. The first major surface 102A may be defined by the abradable layer and the second major surface 102B may be defined by the base layer.

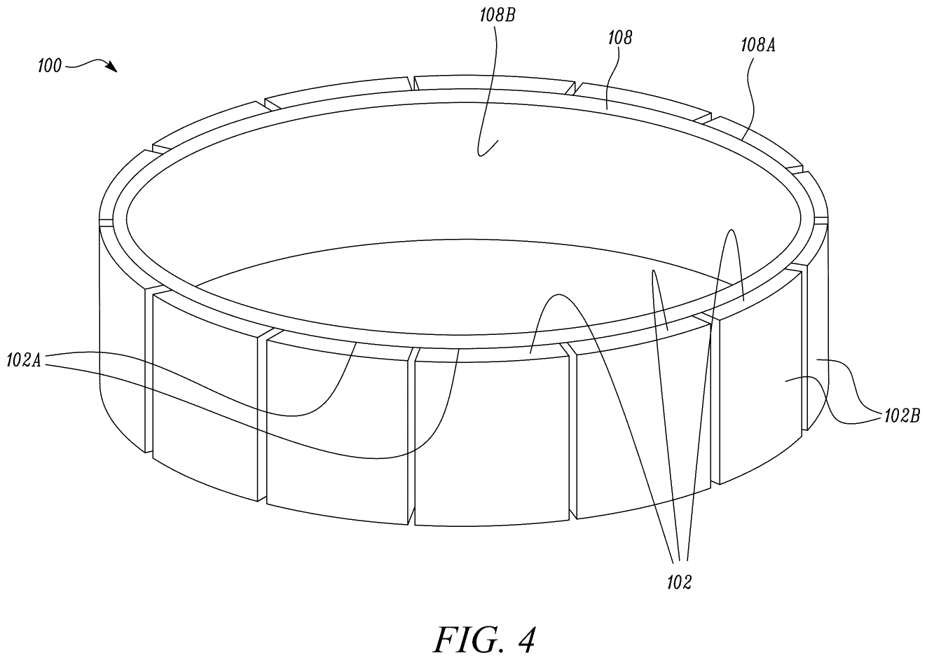

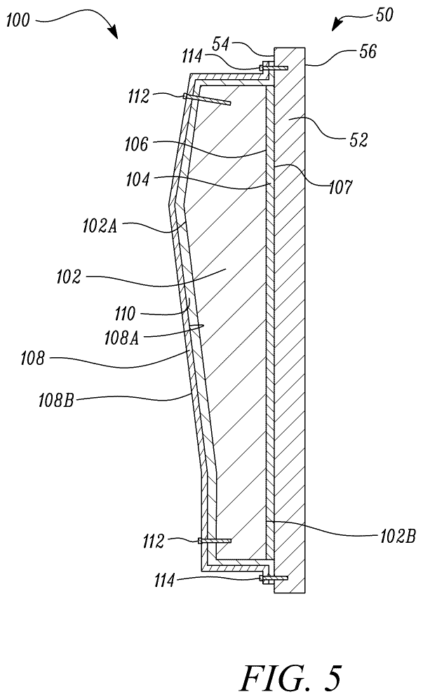

FIGS. 4 and 5 illustrate a system 100 for assembling the fan case 50 (see FIG. 2) of the gas turbine engine 10 (see FIG. 1), according to an embodiment of the present disclosure. Referring to FIGS. 4 and 5, the system 100 includes an annular structure 108 adapted to be disposed within the fan case barrel 52 proximal to the inner surface 54 of the fan case barrel 52. The annular structure 108 may be disposed within the fan case barrel 52 such that the annular structure is concentric with the fan case barrel 52. In an example, the annular structure 108 may be disposed within the fan case barrel 52 via a fixture (not shown). The annular structure 108 defines a first annular surface 108A adapted to face the inner surface 54 of the fan case barrel 52 and a second annular surface 108B radially opposite to the first annular surface 108A. In some embodiments, the annular structure 108 may be made of a composite material, a metallic material, or a polymer.

In the illustrated embodiment of FIGS. 4 and 5, the annular structure 108 is shown as a unitary component for illustrative purposes. In other embodiments, the annular structure 108 may include separate components that may be assembled or removably coupled to each other to form the annular structure 108 based on application requirements.

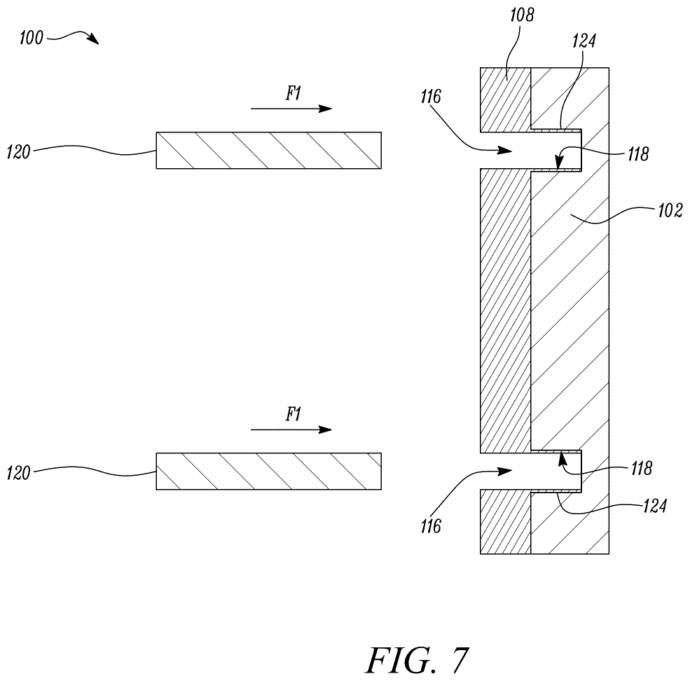

The system 100 further includes the at least one liner 102 that is adapted to be removably coupled to the annular structure 108 at the first annular surface 108A of the annular structure 108. Based on a push force F1 (shown in FIG. 7) applied on the at least one liner 102, the at least one liner 102 is adapted to detach from the annular structure 108 and is pushed towards the inner surface 54 of the fan case barrel 52 to adhesively bond the at least one liner 102 with the fan case barrel 52 via at least one adhesive layer 104.

The plurality of liners 102 may be removably coupled to the annular structure 108 in a retracted position, such that the liners 102 are circumferentially spaced apart from each other. In the illustrated embodiment of FIGS. 4 and 5, fourteen liners 102 are removably coupled to the annular structure 108. However, a total number of the liners 102 may vary as per a size of the fan case barrel 52.

The liner 102 may absorb the energy of impact in case of the blade-off event or due to impact of foreign objects that may be drawn into the gas turbine engine 10 (see FIG. 1). In some embodiments, the at least one liner 102 is made of a metal, a composite material, or a combination thereof. A material of the liner 102 may be chosen such that the liner 102 absorbs the energy of impact in case of the blade-off event or during entry of foreign objects within the gas turbine engine 10. Thus, the liner 102 may maintain a structural integrity of the fan case 50. The material of the liner 102 may also be chosen so as to withstand extreme operating conditions (e.g., high operating temperatures) of the gas turbine engine 10. In some embodiments, the metal of the at least one liner 102 is titanium, aluminum, or a combination thereof. It should be noted that the present disclosure is not limited to a design or a material of the liner 102. Further, the liner 102 may be manufactured by techniques such as, but not limited to, casting and molding.

The system 100 further includes the at least one adhesive layer 104 adapted to contact the inner surface 54 of the fan case barrel 52 of the fan case 50. The at least one adhesive layer 104 may include an inwardly-facing surface 106 that is radially spaced apart from the inner surface 54 of the fan case barrel 52. The at least one adhesive layer is adapted to be disposed on the liner 102 such that the inwardly-facing surface 106 of the at least one adhesive layer 104 faces the second major surface 102B of the at least one liner 102. In an example, the at least one adhesive layer 104 may be disposed on the liner 102 before the annular structure 108 and the liner 102 are disposed within the fan case barrel 52.

Alternatively, the adhesive layer 104 may be disposed on the fan case barrel 52 before the annular structure 108 and the liners 102 are received within the fan case barrel 52. In such cases, the adhesive layer 104 may be disposed on the fan case barrel 52 such that a surface 107 opposite to the inwardly-facing surface 106 of the at least one adhesive layer 104 contacts the inner surface 54 of the fan case barrel 52.

In some embodiments, the at least one adhesive layer 104 may include a structural adhesive film. In an example, the at least one adhesive layer 104 may include a 3M™ Scotch-Weld™ AF 3109-2 structural adhesive film from 3M Company. The adhesive layer 104 may include a high bonding adhesive. In an example, the adhesive layer 104 may include epoxy, without any limitations.

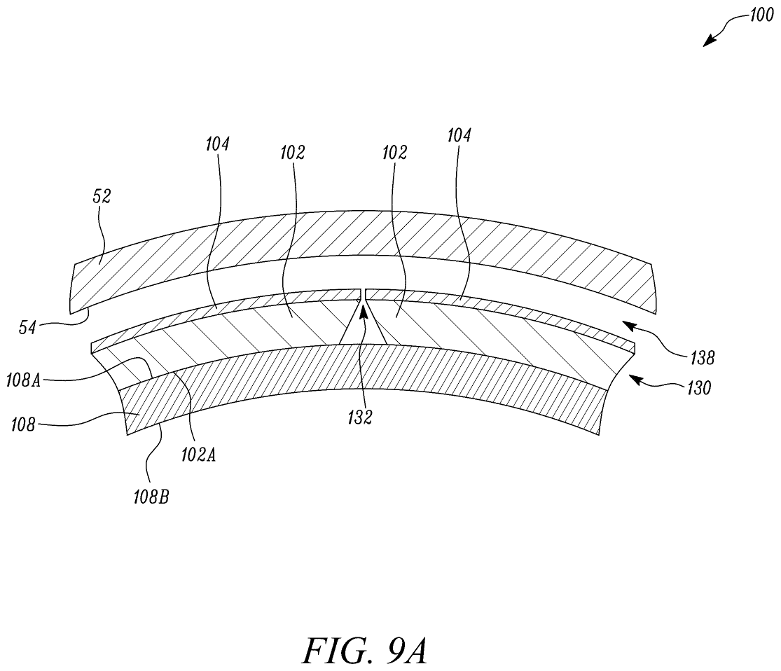

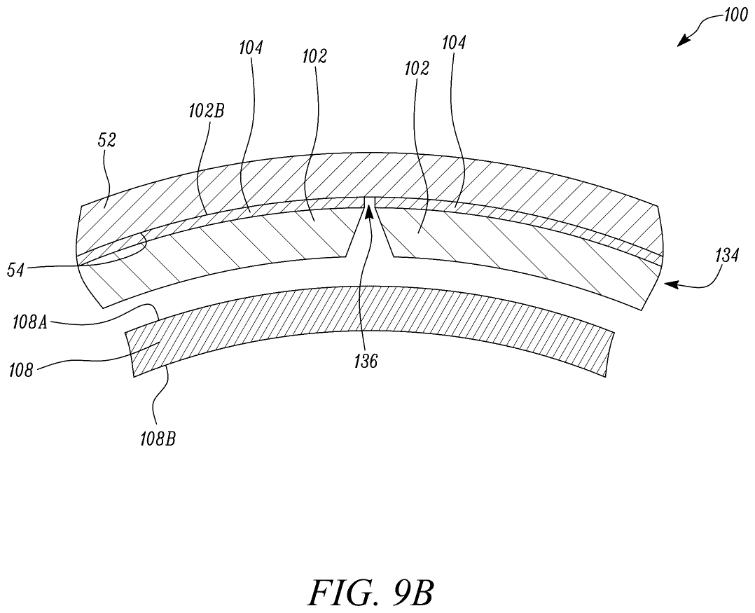

In some embodiments, the at least one adhesive layer 104 includes a plurality of adhesive layers 104 (best visible in FIG. 9) that are circumferentially spaced apart from each other. Each of the plurality of adhesive layers 104 may be disposed between the plurality of liners 102 and the fan case barrel 52. Moreover, the at least one liner 102 includes the plurality of liners 102 corresponding to the plurality of adhesive layers 104. The total number of the liners 102 corresponds to a total number of the adhesive layers 104. Further, the plurality of liners 102 are adapted to be removably coupled to the annular structure 108 and are circumferentially spaced apart from each other. The adhesive layer 104 may adhesively bond each of the plurality of liners 102 to the inner surface 54 of the fan case barrel 52 on heating by a heat source (not shown). The heat source may be chosen as per desired working conditions, applications, and materials associated with the fan case 50. Subsequently, the adhesive layers 104 are cured by the heat source in order to adhesively bond the liners 102 to the inner surface 54 of the fan case barrel 52.

The plurality of adhesive layers 104 may be circumferentially spaced apart from each other. Each of the plurality of adhesive layers 104 may be disposed between a corresponding liner 102 and the fan case barrel 52. The adhesive layer 104 may improve an adhesive bond between the liner 102 and the fan case barrel 52, thereby improving a service life, a durability, and a functionality of the liner 102. The plurality of adhesive layers 104 may ensure that each of the plurality of liners 102 is intact in position while the gas turbine engine 10 is operating at extreme conditions, such as high operating temperatures, without compromising the operational efficiency of the gas turbine engine 10.

Thus, the annular structure 108 of the system 100 is used to couple the liner 102 to the inner surface 54 of the fan case barrel 52 of the fan case 50. The push force F1 (see FIG. 7) applied on the liner 102 detaches the liner 102 from the annular structure 108. Further, the liner 102 is pushed towards the inner surface 54 of the fan case barrel 52 so that the liner 102 adhesively bond with the fan case barrel 52 via the adhesive layer 104.

The system 100 may ensure that the liners 102 coupled to the fan case barrel 52 meet the desired design requirement. Moreover, the system 100 may minimise a risk of damaging the liners 102 during installation of the liners 102, as compared to liners that are installed using conventional techniques. The installation of the liners 102 using the system 100 described herein may improve a quality and a durability of the liners 102. Further, the system 100 ensures that a roundness requirement of the fan case barrel 52 is achieved while the liners 102 are being installed and also during the curing of the adhesive layer 104. Specifically, as the liners 102 are installed when the fan case barrel 52 is fully circular, a stiffness of the fan case barrel 52 may increase and a required round shape of the fan case barrel 52 may be achieved. Moreover, the system 100 may be usable during first assembly or replacement of various types of liners, such as, impact liners and acoustic liners, without compromising the existing design of the liners.

The system 100 may eliminate any additional steps of machining that are inherent in liners that are installed using conventional techniques, thereby reducing manufacturing costs associated with the fan case 50. Furthermore, the liners 102 installed using the system 100 may be compliant to design requirements including profile tolerances, surface tolerances, positional tolerances, and dimensional tolerances. The system 100 may optimise installation safety, quality, and efficiency which the liners 102 are coupled to the fan case barrel 52.

Further, the system 100 described herein may be used as an on-site as well an off-site repair solution during servicing of the fan case. Furthermore, the system 100 may be portable and easy.

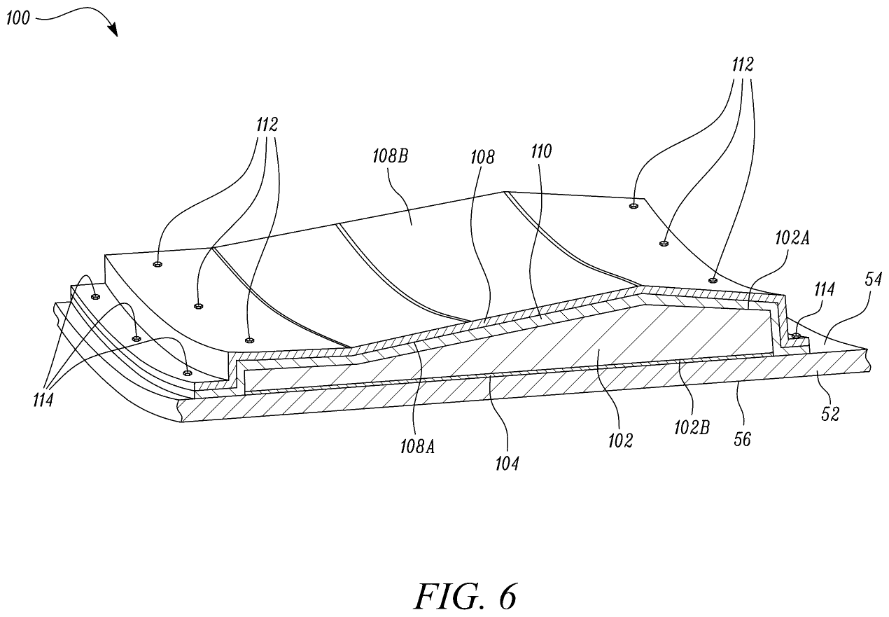

FIG. 6 illustrates a perspective view of a portion of the system 100. Referring to FIGS. 5 and 6, in some embodiments, the system 100 includes a pressure strip 110 removably coupled to the at least one liner 102, the at least one adhesive layer 104, and the fan case barrel 52. The pressure strip 110 is adapted to fully enclose the at least one adhesive layer 104. In the illustrated embodiment of FIGS. 5 and 6, the pressure strip 110 contacts the first major surface 102A of the liner 102. As the pressure strip 110 fully encloses the adhesive layer 104, the pressure strip 110 may allow uniform distribution of pressure along a length of the adhesive layer 104. The pressure strip 110 may provide spew control. In other words, the pressure strip 110 may prevent a flow-out of the adhesive layer 104. The pressure strip 110 may provide a uniform bond thickness of the adhesive layer 104 with minimal to no voids in the adhesive layer 104. As the voids are minimal, an adhesion between the liner 102 and the fan case barrel 52 may be improved, while also improving an in-service life and a functionality of the liner 102.

In some embodiments, the pressure strip 110 includes at least one of a butyl rubber, a platinum cured rubber, a silicone based rubber, and a peroxide cured rubber. The pressure strip 110 made of one of the above listed rubbers may fully enclose the adhesive layer 104 so as to prevent the flow-out of the adhesive layer 104. This may result in the uniform bond thickness of the adhesive layer 104 and minimal to no voids in the adhesive layer 104, thereby improving adhesion between the liner 102 and the fan case barrel 52.

In some embodiments, the system 100 further includes one or more first coupling elements 112 adapted to removably couple the at least one liner 102 to the annular structure 108. In the illustrated embodiment of FIGS. 5 and 6, each liner 102 is coupled to the annular structure 108 by six first coupling elements 112. Further, a total number of the first coupling elements 112 may be based on the total number of the liners 102. The one or more first coupling elements 112 may allow easy coupling of the annular structure 108 with the liner 102 and may be easy to remove when the liner 102 is to be detached from the annular structure 108. Each of the one or more first coupling elements 112 may be received within corresponding through-openings (not shown) defined in the annular structure 108 and openings (not shown) defined in the liner 102, to hold the liner 102 in position relative to the annular structure 108.

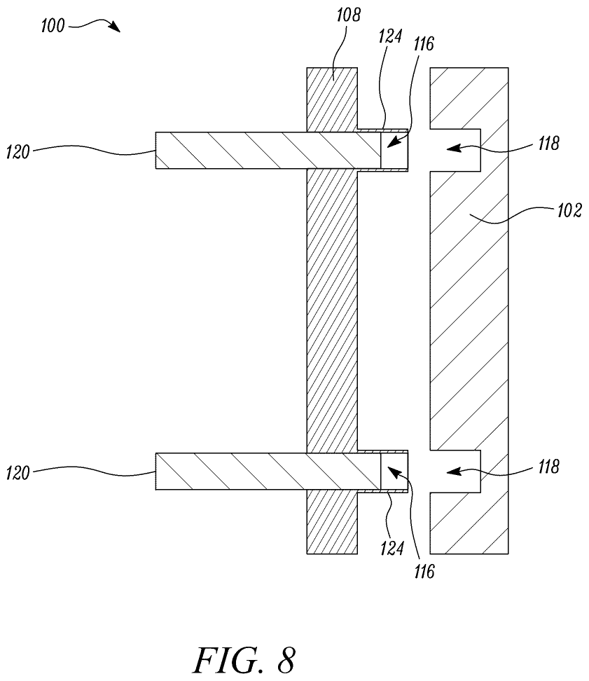

In some embodiments, each of the one or more first coupling elements 112 includes a mechanical fastener 112 or a coupling feature (same as a coupling feature 124 that will be explained in relation to FIGS. 7 and 8) extending from the first annular surface 108A of the annular structure 108. In the illustrated embodiment of FIGS. 5 and 6, the one or more first coupling elements 112 are embodied as the mechanical fasteners. The first coupling elements 112 may be hereinafter interchangeably referred to as “the mechanical fasteners” and denoted using identical reference numeral “112”. It should be noted that the first coupling elements 112 may include any other type of coupling elements that allows removable coupling of the liner 102 to the annular structure 108.

The mechanical fasteners 112 may include bolts, pins, screws, and the like. The mechanical fasteners 112 can also serve as additional alignment elements. In an example, the mechanical fasteners 112 and a technique of coupling using the mechanical fasteners 112 may be similar to details explained for the fasteners in United States patent application U.S. Ser. No. 18/479846 titled “CURING AND BONDING TOOL” owned by the assignee of the present application.

In some embodiments, the system 100 further includes one or more second coupling elements 114 adapted to removably couple the annular structure 108 to the fan case barrel 52. In the illustrated embodiment of FIGS. 5 and 6, the system 100 includes six second coupling elements 114 for each liner 102. A total number of the second coupling elements 114 may be based on the total number of the liners 102. The one or more second coupling elements 114 may allow easy coupling of the annular structure 108 with the fan case barrel 52 and may be easy to remove from the annular structure 108 after curing of the adhesive layer 104. Each of the one or more second coupling elements 114 may be received within through-openings (not shown) defined in the annular structure 108 and openings (not shown) defined in the fan case barrel 52, to hold the liner 102 in position relative to the annular structure 108 and the fan case barrel 52.

Each of the one or more second coupling elements 114 may maintain the position of the liners 102 relative to the fan case barrel 52 while the adhesive layers 104 are being cured. Specifically, each of the one or more second coupling elements 114 may be used to control positional tolerances of the liners 102 while the adhesive layers 104 are being cured. In some embodiments, each of the one or more second coupling elements 114 includes a mechanical fastener 114. In the illustrated embodiment of FIGS. 5 and 6, the one or more second coupling elements 114 are embodied as the mechanical fasteners. The second coupling elements 114 may be hereinafter interchangeably referred to as “the mechanical fasteners” and denoted using identical reference numeral “114”. The mechanical fasteners 114 may include bolts, pins, screws, and the like. It should be noted that the second coupling elements 114 may include any other type of coupling elements that allows removable coupling of the annular structure 108 to the fan case barrel 52.

FIG. 7 illustrates a cross-sectional view of a portion of the system 100. In the illustrated embodiment of FIG. 7, each of the one or more first coupling elements 112 includes a coupling feature 124 extending from the first annular surface 108A of the annular structure 108. Specifically, the coupling features 124 are embodied as projections extending from the first annular surface 108A. In the illustrated embodiment of FIG. 7, the annular structure 108 includes a plurality of holes 116. Further, each liner 102 from the plurality of liners 102 includes a plurality of holes 118. The coupling feature 124 may be received within a corresponding hole 118 in the liner 102 to removably couple the liner 102 with the annular structure 108.

The system 100 further includes a detachment device 120 adapted to apply the push force F1 to detach the at least one liner 102 from the annular structure 108. The push force F1 may be applied by the detachment device 120 to detach the liner 102 from the annular structure 108. The push force F1 applied by the detachment device 120 causes the liner 102 to be disposed in the bonding position, i.e., proximal to the inner surface 54 of the fan case barrel 52.

In some embodiments, the detachment device 120 includes one or more clamps, one or more actuators, or an inflatable ring. The one or more clamps, the one or more actuators, or the inflatable ring may ensure easy detachment of the liners 102 from the annular structure 108 to dispose the liners 102 in the bonding position. Further, the detachment device 120 may be manually operated. Alternatively, the detachment device 120 may be automated to apply the push force F1. The detachment device 120 may include robotic arms, spider legs, electro-mechanical actuators, electric actuators, hydraulic actuators, pneumatic actuators, and the like. It should be noted that the present disclosure is not limited by a type of the detachment device 120.

As shown in FIG. 8, in order to detach the liner 102, the detachment device 120 is received within the holes 116, 118 of the annular structure 108 and the liner 102. Further, the detachment device 120 may apply the push force F1 of the liner 102. The application of the push force F1 results in removal of the coupling feature 124 from the hole 118 of the corresponding liner 102, thereby detaching the liner 102 from the annular structure 108.

FIG. 9A is a schematic cross-sectional top view of the liners 102 before applying the push force F1 (see FIG. 7). In some embodiments, when each of the plurality of liners 102 is removably coupled to the annular structure 108, each of the plurality of liners 102 is disposed in a first position 130. In the first position 130, each liner 102 from the plurality of liners 102 is circumferentially spaced apart from an adjacent liner 102 from the plurality of liners 102 by a first gap 132. In the first position 130, each of the plurality of liners 102 may be removably coupled to the annular structure 108 in the retracted position by using the one or more first coupling elements 112.

It should be noted that, a diameter of the annular structure 108 is decided such that, when the liners 102 are coupled to the annular structure 108, a radial gap 138 is disposed between the liner 102 and the inner surface 54 of the fan case barrel 52.

FIG. 9B is a schematic cross-sectional top view of the liners 102 after applying the push force F1 (see FIG. 7). In some embodiments, upon detachment of each of the plurality of liners 102 from the annular structure 108, each of the plurality of liners 102 is disposed in a second position 134. In the second position 134, each liner 102 from the plurality of liners 102 is circumferentially spaced apart from the adjacent liner 102 from the plurality of liners 102 by a second gap 136. The second gap 136 is greater than the first gap 132. Further, the second gap is same as the gap 103 (shown in FIG. 2). In the second position 134, each of the plurality of liners 102 is detached from the annular structure 108 and is disposed proximal to the inner surface 54 of the fan case barrel 52. Further, the radial gap 138 may also allow accommodate the liners 102 in proximity to the fan case barrel 52 after the liners 102 are detached form the annular structure 108. It should be noted that the first gap 132 and the second gap 136 are governed by design requirements of the fan case 50.

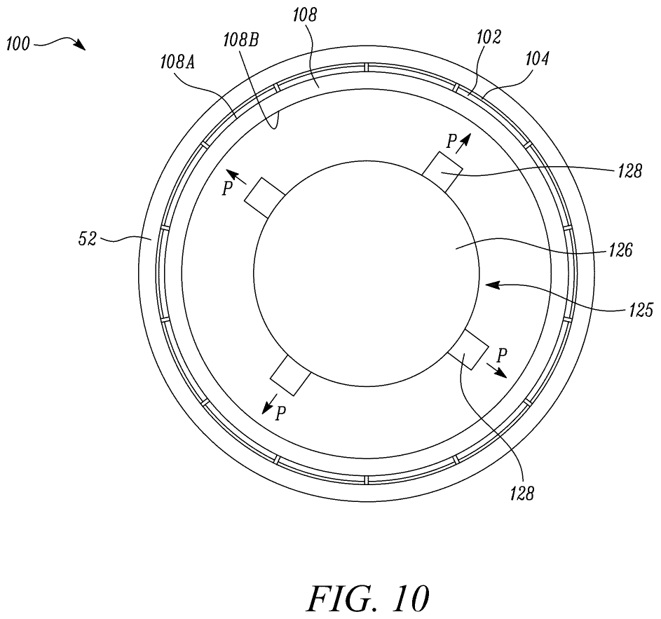

Referring now to FIG. 10, the system 100 further includes a pressure applicator 125 adapted to apply a uniform pressure P on the second annular surface 108B of the annular structure 108 to adhesively bond the at least one liner 102 with the fan case barrel 52 via the at least one adhesive layer 104.

The application of the uniform pressure P on the annular structure 108 may be in turn applied on the liner 102 which may cause the liner 102 to be pushed towards the fan case barrel 52 for bonding, while maintaining the uniform bond thickness of the adhesive layer 104 and minimal to no voids in the adhesive layer 104. As the voids are minimal, an adhesion between the liners 102 and the fan case barrel 52 may be improved. Further, the pressure applicator 125 may continue to apply the unform pressure P during the curing of the adhesive layer 104. The uniform pressure P applied by the pressure applicator 125 may replicate pressures that are applied during a conventional vacuum bag process. Further, application of the uniform pressure P on the liner 102 may ensure that the fan case barrel 52 is in a round state, thereby meeting the roundness requirement of the fan case barrel 52 which may improve a quality of the fan case barrel 52.

In some embodiments, the pressure applicator 125 includes one or more clamps, one or more actuators 128, or an inflatable ring. In some embodiments, the pressure applicator 125 may be automated, and may be controlled via a controller. Further, the pressure applicator 125 may be actuated via an electro-mechanical system, an electrical system, a hydraulic system, or a pneumatic system. In the illustrated embodiment of FIG. 10, the pressure applicator 125 includes a fixture 126 and the actuators 128. A number of the actuators 128 as illustrated herein is exemplary, and the pressure applicator 125 may include any number of the actuators 128. In an example, a total number of the actuators 128 may correspond to the total number of the liners 102. The fixture 126 holds the actuators 128 in position relative to the annular structure 108. The actuators 128 may include an electro-mechanical actuator, an electrical actuator, a hydraulic actuator, or a pneumatic actuator. It should be noted that the present disclosure is not limited by a type and an arrangement of the pressure applicator 125.

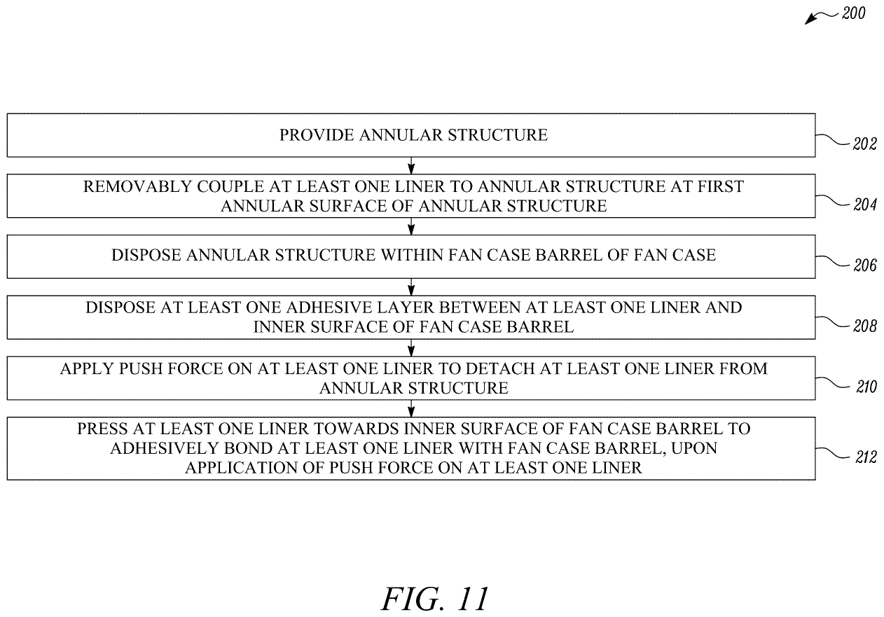

FIG. 11 is a flowchart for a method 200 for assembling the fan case 50 of the gas turbine engine 10 (see FIG. 1), according to an embodiment of the present disclosure.

With reference to FIGS. 1 to 11, at step 202, the annular structure 108 is provided. The annular structure 108 defines the first annular surface 108A and the second annular surface 108B radially opposite to the first annular surface 108A.

At step 204, at least one liner 102 is removably coupled to the annular structure 108 at the first annular surface 108A of the annular structure 108. In some embodiments, the step 204 further includes removably coupling, via the one or more first coupling elements 112, the at least one liner 102 to the annular structure 108. In some embodiments, the step 204 further includes removably coupling each of the plurality of liners 102 to the first annular surface 108A in the first position 130. In the first position 130, each liner 102 from the plurality of liners 102 is circumferentially spaced apart from the adjacent liner 102 from the plurality of liners 102 by the first gap 132.

At step 206, the annular structure 108 is disposed within the fan case barrel 52 of the fan case 50. The annular structure 108 is disposed proximal to the inner surface 54 of the fan case barrel 52, such that the first annular surface 108A of the annular structure 108 faces the inner surface 54 of the fan case barrel 52.

At step 208, the at least one adhesive layer 104 is disposed between the at least one liner 102 and the inner surface 54 of the fan case barrel 52. The at least one adhesive layer 104 is adapted to adhesively bond the at least one liner 102 with the fan case barrel 52.

At step 210, the push force F1 is applied on the at least one liner 102 to detach the at least one liner 102 from the annular structure 108. In some embodiments, the step 210 further includes application of the push force F1 to detach the at least one liner 102 from the annular structure 108 via the detachment device 120.

In some embodiments, the at least one adhesive layer 104 includes the plurality of adhesive layers 104 that are circumferentially spaced apart from each other. The at least one liner 102 includes the plurality of liners 102 corresponding to the plurality of adhesive layers 104. The plurality of liners 102 are adapted to be removably coupled to the annular structure 108 and are circumferentially spaced apart from each other. Each of the plurality of liners 102 is adapted to be adhesively bonded to the inner surface 54 of the fan case barrel 52 by the corresponding adhesive layer 104 from the plurality of adhesive layers 104. In some embodiments, the step 210 of applying the push force F1 on the at least one liner 102 further includes applying the push force F1 on each of the plurality of liners 102 to detach each of the plurality of liners 102 from the annular structure 108.

At step 212, the at least one liner 102 is pressed towards the inner surface 54 of the fan case barrel 52 to adhesively bond the at least one liner 102 with the fan case barrel 52, upon application of the push force F1 on the at least one liner 102.

In some embodiments, the method 200 further includes a step at which the one or more second coupling elements 114 removably couple the annular structure 108 to the fan case barrel 52.

In some embodiments, the method 200 further includes a step at which the pressure strip 110 is removably coupled to the at least one liner 102, the at least one adhesive layer 104, and the fan case barrel 52. The pressure strip 110 is adapted to fully enclose the at least one adhesive layer 104.

In some embodiments, the method 200 further includes a step at which the pressure applicator 125 applies the uniform pressure P on the second annular surface 108B of the annular structure 108 to adhesively bond the at least one liner 102 with the fan case barrel 52 via the at least one adhesive layer 104.

In some embodiments, the method 200 further includes a step at which each of the plurality of liners 102 are disposed in the second position 134 upon detachment of each of the plurality of liners 102 from the annular structure 108. In the second position 134, each liner 102 from the plurality of liners 102 is circumferentially spaced apart from the adjacent liner 102 from the plurality of liners 102 by the second gap 136. The second gap 136 is greater than the first gap 132.

It should be noted that, during actual implementation, an order in which the steps of the method 200 are performed may vary from what is explained above and illustrated in FIG. 11, as per requirements. Moreover, multiple steps may be performed together.

Further, the gas turbine engine 10 includes the fan case 50 that is assembled by the method 200 explained above. The fan case 50 may be assembled in a cost-effective manner and may have a longer service life due to the liners 102 adhesively bonded at the inner surface 54 of the fan case barrel 52. Moreover, fan case 50 may be assembled/repaired on-site as well off-site based on application requirements.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A system for assembling a fan case of a gas turbine engine, the system comprising:
at least one adhesive layer adapted to contact an inner surface of a fan case barrel of the fan case;
an annular structure adapted to be disposed within the fan case barrel proximal to the inner surface of the fan case barrel, wherein the annular structure defines a first annular surface adapted to face the inner surface of the fan case barrel and a second annular surface radially opposite to the first annular surface; and
at least one liner adapted to be removably coupled to the annular structure at the first annular surface of the annular structure, wherein, based on a push force applied on the at least one liner, the at least one liner is adapted to detach from the annular structure and is pushed towards the inner surface of the fan case barrel to adhesively bond the at least one liner with the fan case barrel via the at least one adhesive layer.

2. The system of claim 1, further comprising a pressure strip removably coupled to the at least one liner, the at least one adhesive layer, and the fan case barrel, wherein the pressure strip is adapted to fully enclose the at least one adhesive layer.

3. The system of claim 2, the pressure strip includes at least one of a butyl rubber, a platinum cured rubber, a silicone based rubber, and a peroxide cured rubber.

4. The system of claim 1, further comprising a pressure applicator adapted to apply a uniform pressure on the second annular surface of the annular structure to adhesively bond the at least one liner with the fan case barrel via the at least one adhesive layer.

5. The system of claim 4, wherein the pressure applicator includes one or more clamps, one or more actuators, or an inflatable ring.

6. The system of claim 1, further comprising one or more first coupling elements adapted to removably couple the at least one liner to the annular structure.

7. The system of claim 6, wherein each of the one or more first coupling elements includes a mechanical fastener or a coupling feature extending from the first annular surface of the annular structure.

8. The system of claim 1, further comprising a detachment device adapted to apply the push force to detach the at least one liner from the annular structure.

9. The system of claim 8, wherein the detachment device includes one or more clamps, one or more actuators, or an inflatable ring.

10. The system of claim 1, further comprising one or more second coupling elements adapted to removably couple the annular structure to the fan case barrel.

11. The system of claim 10, wherein each of the one or more second coupling elements includes a mechanical fastener.

12. The system of claim 1, wherein the at least one adhesive layer includes a plurality of adhesive layers that are circumferentially spaced apart from each other, wherein the at least one liner includes a plurality of liners corresponding to the plurality of adhesive layers, wherein the plurality of liners are adapted to be removably coupled to the annular structure and are circumferentially spaced apart from each other, and wherein, upon application of the push force on each of the plurality of liners, each of the plurality of liners detaches from the annular structure and is pushed towards the inner surface of the fan case barrel to adhesively bond each of the plurality of liners with the fan case barrel via a corresponding adhesive layer from the plurality of adhesive layers.

13. The system of claim 12, wherein, when each of the plurality of liners is removably coupled to the annular structure, each of the plurality of liners is disposed in a first position, and wherein, in the first position, each liner from the plurality of liners is circumferentially spaced apart from an adjacent liner from the plurality of liners by a first gap.

14. The system of claim 13, wherein, upon detachment of each of the plurality of liners from the annular structure, each of the plurality of liners is disposed in a second position, wherein, in the second position, each liner from the plurality of liners is circumferentially spaced apart from the adjacent liner from the plurality of liners by a second gap, and wherein the second gap is greater than the first gap.

15. A method for assembling a fan case of a gas turbine engine, the method comprising the steps of:
providing an annular structure, wherein the annular structure defines a first annular surface and a second annular surface radially opposite to the first annular surface;
removably coupling at least one liner to the annular structure at the first annular surface of the annular structure;
disposing the annular structure within a fan case barrel of the fan case, wherein the annular structure is disposed proximal to an inner surface of the fan case barrel, such that the first annular surface of the annular structure faces the inner surface of the fan case barrel;
disposing at least one adhesive layer between the at least one liner and the inner surface of the fan case barrel, wherein the at least one adhesive layer is adapted to adhesively bond the at least one liner with the fan case barrel;
applying a push force on the at least one liner to detach the at least one liner from the annular structure; and
pressing the at least one liner towards the inner surface of the fan case barrel to adhesively bond the at least one liner with the fan case barrel, upon application of the push force on the at least one liner.

16. The method of claim 15, further comprising removably coupling a pressure strip to the at least one liner, the at least one adhesive layer, and the fan case barrel, wherein the pressure strip is adapted to fully enclose the at least one adhesive layer.

17. The method of claim 15, further comprising applying, via a pressure applicator, a uniform pressure on the second annular surface of the annular structure to adhesively bond the at least one liner with the fan case barrel via the at least one adhesive layer.

18. The method of claim 15, wherein the step of removably coupling the at least one liner to the annular structure at the first annular surface of the annular structure further includes removably coupling, via one or more first coupling elements, the at least one liner to the annular structure.

19. The method of claim 15, wherein the step of applying the push force further includes applying, via a detachment device, the push force to detach the at least one liner from the annular structure.

20. The method of claim 15, further comprising removably coupling, via one or more second coupling elements, the annular structure to the fan case barrel.
